(19) United States
(12) Patent Application Publication
(10) Pub. No.: US 2006/0080239 A1
(43) Pub. Date: Apr. 13, 2006

(54) System and method for pay-per-click revenue sharing

(76) Inventor: Kenneth Lewis Hartog, New York, NY (US)

Correspondence Address: BAKER & BOTTS, 30 ROCKEFELLER PLAZA, NEW YORK, NY, 10112, US

(21) Appl. No.: 11/086,813

(22) Filed: Mar. 22, 2005

Related U.S. Application Data
(60) Provisional application No. 60/617,470, filed on Oct. 8, 2004.

(51) Int. Cl. G06Q 40/00

(52) U.S. Cl. 705/40

(57) ABSTRACT

A method for revenue sharing in Internet pay-per-click advertising wherein a user designates an entity and makes at least one click, the least one click generates revenue and the entity receives at least a portion of the revenue generated by the user's at least one click. A method for generating revenue from unpaid search results by participating in an affiliate program.

### CROSS-REFERENCE TO RELATED APPLICATION

This application claims priority based on U.S. Provisional Patent Application entitled “REVENUE SHARE PAY PER CLICK MODEL,” Ser. No. 60/617,470, which was filed on Oct. 8, 2004.

### FIELD OF THE INVENTION

The present invention relates to a system and method for revenue sharing in Internet advertising models. In particular, the present invention relates to a system and method for revenue sharing in pay-per-click Internet advertising and to an affiliate revenue program to compensate for lost revenue.

### BACKGROUND INFORMATION

The traditional search engine revenue model has been to generate revenue via advertising. The search engine attracts users by giving away free search results in answer to a query from the user. The most recent and popular form of advertising has been “pay-per-click” advertising.

For example, when an Internet user queries a search engine, the search engine returns a list of search results. At the top of the list or on the side of the search results page, there is a section called “sponsored links” or “sponsored results” which are paid for by advertisers. Advertisers pay a fee to the search engine every time a user clicks on their sponsored link. The advertisers bid for their ads to be placed closest to the top of the list. The highest revenue generating ads appear at the top-most position of the search results. This is the pay-per-click model for search results listings. There are also what are known as “organic” or unpaid results which are generated by the search engine via search algorithms or other methods, such as human editing or other. These unpaid results traditionally have not generated revenues. However, the accuracy of these results is more useful to users and has attracted more users to a particular search engine. The search engine “gives away” the “organic” results to attract an audience, so that some of these people will click on the “sponsored” or “paid” results which do generate revenue.

Pay-per-click is also used in connection with banner ads, pop-up ads and other Internet advertising models.

Currently, however, the profits from pay-per-click advertiser accounts go to the search engines themselves or to a pre-determined beneficiary that is not of the surfer's choice. Or alternatively, the website may have a pre-determined beneficiary that is chosen by the website itself. The user has no choice as to the recipient of the revenue which is generated by his actions. When the internet user clicks on a sponsored or paid link, the fee or bid amount is paid from the advertiser to the search engine. Should a user click on an un-sponsored (organic) result, no fee is paid to the search engine.

Charities or other organizations or funds are perpetually seeking donations to fund their charitable activities. Most charities have difficulties raising funds. Charities have many different ways of raising money. For example, selling items and using the profits, soliciting funds through mailings to the public, soliciting funds through advertisements in newspapers and magazines, and organizing fundraising events such as benefit auctions. It is difficult for charities to obtain a long-term and steady income stream.

Charity donation methods also exist on the Internet. For example, websites such as www.thehungersite.com, allow Internet users to click on a link to make a free donation to a charity. The sponsors have advertisements on the website. The sponsors of the website make the donation. The deficiency in this method is that an Internet user has to go out of his/her way to make the donation and has no ability to designate the recipient of the proceeds. The beneficiary is pre-determined by the website. The website has no other use to the Internet user. The number of people who visit this website will therefore be limited because they have no other incentive to visit the site. The audience of this website is limited to the number of people interested in that particular cause and charity. The site has no independent utility to the user. An Internet user who wants to donate to the entity of his/her choice will not use this type of website.

Another method for soliciting charity donations on the Internet is exemplified by www.charitycafe.com. However, this website only supports three specific charities, namely, Greenpeace, WWF, and Oxfam. The user must visit this website and use one of the linked search engines, Lycos or AskJeeves. These search engines pay charitycafe.com a small per-search fee for each search that comes through the charitycafe.com website. Charitycafe.com then donates that money to the three charities. This method is limited in that only three charities benefit from it and the user has no choice as to the beneficiary. Additionally, the revenue is generated on a per-search basis and not as a portion of pay-per-click revenue generated by a specific user. There is also very little revenue generated by this method. Approximately $280.00 per month is currently being donated to these three charities collectively as a result of charitycafe.com. An Internet user who wants to donate to the entity of his/her choice will not use this type of website. There is no incentive for a user to click on sponsored or paid link does not exist.

There is a need for a system by which the user who has generated the revenue for the search engine via his/her search and subsequent click to have a say in what happens to the revenues generated by his/her actions.

There is a need in the art to develop a system and method whereby Internet users can donate to an entity of their choice by utilizing a website that is independently useful to them but does not cost them anything. This will encourage greater donations to charities than previously existing methods. It will also allow charities to obtain a more steady income.

There is also a need for search engines to generate revenue from the organic or unpaid search results in order to make up for the revenue transferred to the entity designated by the user.

### BRIEF SUMMARY OF THE INVENTION

Accordingly, it is a general objective of this invention to provide a system and method for sharing revenues from pay-per-click Internet advertising. It is a further objective of this invention to provide a system and method for charity and other incentives in pay-per-click Internet advertising. It is yet another objective of the present invention to provide a system and method for allowing the revenue from pay-per-click search listing results to be shared by charities or other entities. It is another objective of the present invention to provide a method for generating revenue from unpaid search results.

These and other objectives are achieved by a system and method including a website where a user designates at least one charity or entity, a database that keeps track of the user's clicks and credits the entity with a portion of the revenue generated by the user's clicks. These and other objectives are also achieved by an internet affiliate programs for generating revenue from unpaid search results.

### DETAILED DESCRIPTION OF PREFERRED EMBODIMENTS

The present invention, in one embodiment, is a system and method for revenue sharing in Internet pay-per-click advertising.

A user of a website designates at least one entity. The at least one entity can be a charity, a person, a 509 plan, or a stock account, for example. The at least one entity will share the revenue generated by the user's at least one click on a pay-per-click advertisement on the website.

The user creates an account on the website by entering personal information on a web page. This personal information can include such information as the name, user name, e-mail address, or other identifying information of the user. It can also include a password unique to the user. Alternatively, the website can assign a user name and/or password to the user. The user can also give personal information to a representative of the website who then creates the account. The user need not create an account.

The user account information and entity designation can be stored in a database. The website can also place a cookie on the computer that is being used by the user to access the website. The cookie automatically identifies the user from that computer. A cookie is not necessary but negates the need for the user to sign in every time he uses the website. The click history of the user may be stored in a database.

The user goes to the website or a third party entity representing the website and begins using the website. The website includes pay-per-click advertising such as sponsored search results, banner ads, pop-up ads or other pay-per-click Internet advertising. The user clicks on at least one pay-per-click advertisement. When the user clicks on the pay-per-click advertisement, revenue is generated. The advertiser pays the website a certain amount of money for the click. The website then credits the user's account with at least a portion of the revenue generated by the click. The at least a portion may be 25% or any other percentage of the revenue generated by the click. The process is repeated each time the user clicks on a pay-per-click advertisement.

Alternatively, the user can simply designate an entity for revenue sharing without creating a user account. The at least a portion of the revenue generated by the click goes directly to the entity designated by the user.

In one embodiment of the present invention, a user comes to a search engine website. The user creates an account on an account set-up page of the website. The user then designates a charity. The user logs onto the website using his/her account information. The user performs a search and a list of results is displayed. Some of the results may be sponsored results or sponsored listings. The sponsors of these links, the advertisers, will pay the website a certain amount of money for each click that a user makes on that advertiser's link. If the user clicks on a sponsored link, the advertiser pays the search engine a certain amount of money, and the search engine credits 25% or any other percent, for example, of that money to the user's account and then donates the 25% to the charity that the user designated.

In the system and method, the website may also set up a page where users and the public can see the donations made by the website.

The system and method may also include a fraud protection scheme so that fraudulent clicks are not generated. The fraud protection scheme may be include tracking user's IP addresses and logging unusual click trends or other methods.

In another embodiment, an affiliate program generates affiliate revenue for a search engine website. If a user performs a search and clicks on an unsponsored search result, or “organic” search result, to a website with whom the owner of the present invention is affiliated, and then performs an action on that website pursuant to the affiliate agreement, the search engine will be compensated for the referral as per the terms of the affiliate agreement. The revenue from the action can therefore be shared by the search engine or other entities but does not necessarily have to be.

For example, a user performs a search on the present website, or via any other method such as a toolbar or on a 3^{rd} party website which represents the search engine, for the term “Credit Report” and several results are listed. The user clicks on an unsponsored or “organic” result for www.qspace.com. The unsponsored result is not paid for by qspace.com but is generated via the organic search method employed by search engine. The present website is an affiliate of www.qspace.com and has an affiliate agreement with www.qspace.com. The method of the present invention will redirect the user to an affiliate URL assigned to it by qspace.com, for example www.qspace.com/affid=presentwebsite. Alternatively, there may be a different method wherein an affiliate URL is not needed and the user is directed to the actual website www.qspace.com. If the user then performs an action which would entitle the referrer (present website) to compensation as per the affiliate agreement, the present website would receive a referral fee from qspace.com in conjunctions with the terms of qspace.com's affiliate agreement. For example, if the user purchases a credit report from www.qspace.com, the present website would receive compensation.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

I claim:

1. A method for revenue sharing in Internet pay-per-click advertising wherein a user designates an entity and makes at least one click, said at least one click generating revenue, and wherein said entity receives at least a portion of said revenue generated by said at least one click.

2. A method for revenue sharing in Internet pay-per-click advertising wherein a user of a search engine designates an entity, the user makes at least one click on a paid search result, said at least one click generating revenue, and wherein said entity receives a portion of said revenue generated by said at least one click.

3. A method for revenue sharing in Internet pay-per-click advertising, the method comprising the steps of:
creating a user account;
creating user account information including a user's personal information and a designation of at least one entity;
storing said user account information in a database;
clicking, by said user, on at least one pay-per-click advertisement on an Internet website;
storing said user's click history in a database;
crediting said user account with at least a portion of revenue generated by said user's at least one click;
transferring said at least a portion of revenue generated by said user's at least one click to said at least one entity.

4. The method of claim 3 wherein said user chooses identity of said at least one entity.

5. The method of claim 3 further comprising the step of placing a cookie on said user's computer.

6. The method of claim 3 further comprising the step of displaying certain revenue amounts to the public.

7. The method of claim 3 further comprising the step of providing a fraud protection scheme.

8. A system for revenue sharing in Internet pay-per-click advertising, the system comprising:
a user account;
user account information including a user's personal information and a designation of at least one entity,
at least one click, by said user, on at least one pay-per-click advertisement on an Internet website;
said user's click history which is stored in a database;
a credit to said user's account in the amount of at least a portion of revenue generated by said user's at least one click;
transfer of said at least a portion of revenue generated by said user's at least one click to said at least one entity.

9. The system of claim 8 wherein said user chooses identity of said at least one entity.

10. The system of claim 8 further comprising a cookie placed on said user's computer.

11. The system of claim 8 further comprising a display of certain revenue amounts to the public.

12. The system of claim 8 further comprising a fraud protection scheme.

13. An internet affiliate program for revenue sharing wherein a search engine website becomes an affiliate of at least one other website, a user of the search engine website performs a search on the search engine website and clicks on an unpaid link to the at least one other website from a list of search results, said user performing an action on the at least one other website, the search engine website receiving at least a portion of the revenue generated from said action.

14. An internet affiliate program for revenue sharing wherein a search engine website becomes an affiliate of at least one other website, a user of the search engine website performs a search on the search engine website and clicks on an unpaid link to the at least one other website from a list of search results, said user performing an action commensurate with an affiliate agreement of the at least one other website, and said search engine website receiving compensation commensurate with said affiliate agreement.

15. A method for revenue sharing in an internet affiliate program comprising the steps of:
a search engine becoming an affiliate of at least one other website;
a user of said search engine performing a search;
said search engine returning a list of search results;
said user clicking on a search result which is a link to the at least one other website;
said user performing an action on said at least one website commensurate with an affiliate agreement with said at least one other website;
said search engine receiving revenue in compliance with the affiliate agreement of said at least one other website.

16. A method for revenue sharing in an internet affiliate program comprising the steps of:
a search engine becoming an affiliate of at least one other website;
a user of said search engine performing a search;
said search engine returning a list of search results;
said user clicking on a search result which is a link to the at least one other website;
said user being directed to the at least one other website;
said user performing an action on said at least one website commensurate with an affiliate agreement with said at least one website;
said search engine receiving revenue in compliance with the affiliate agreement of said at least one other website.

17. A search engine wherein revenue is generated by users clicking on organic results.
